(19) United States
(12) Patent Application Publication
(10) Pub. No.: US 2021/0061725 A1
(43) Pub. Date: Mar. 4, 2021

(54) Fertilizer Using Fish and Wild Animals and Manufacturing Method Thereof

(71) Applicant: Shin Chul Han, Chungcheongbuk (KR)

(72) Inventor: Shin Chul Han, Chungcheongbuk (KR)

(21) Appl. No.: 16/960,009

(22) PCT Filed: Jan. 7, 2019
(86) PCT No.: PCT/KR2019/000172

§ 371 Date: Jul. 2, 2020

(30) Foreign Application Priority Data
Jan. 5, 2018 (KR) 10-2018-0001570
Jan. 7, 2019 (KR) 10-2019-0001480

(51) Int. Cl. C05F 11/08; C05F 9/00; C05F 1/00; C05F 5/00

(52) U.S. Cl. CPC C05F 11/08; C05F 9/00; C05F 5/00; C05F 1/002; C05F 1/005

(57) ABSTRACT

A method of manufacturing fertilizer is provided. The method comprises preparing a primary mixture comprising of 80 to 90 percent in weight of crushed fish less than 100 mesh in size, 5 to 10 percent in weight of corn stalk less than 100 mesh in size, and 5 to 10 percent in weight of rice bran less than 100 mesh in size. The primary mixture is boiled at twice barometric pressure to obtain an extracted mixture. A secondary mixture is prepared comprising 86 to 93 percent in weight of the extracted mixture and 1 to 2 percent in weight of powdered, smaller than 100 mesh size, peat moss, elvan, tourmaline, zeolite, sericite, and minerals from red clay. The secondary mixture is fermented with lactobacillus.

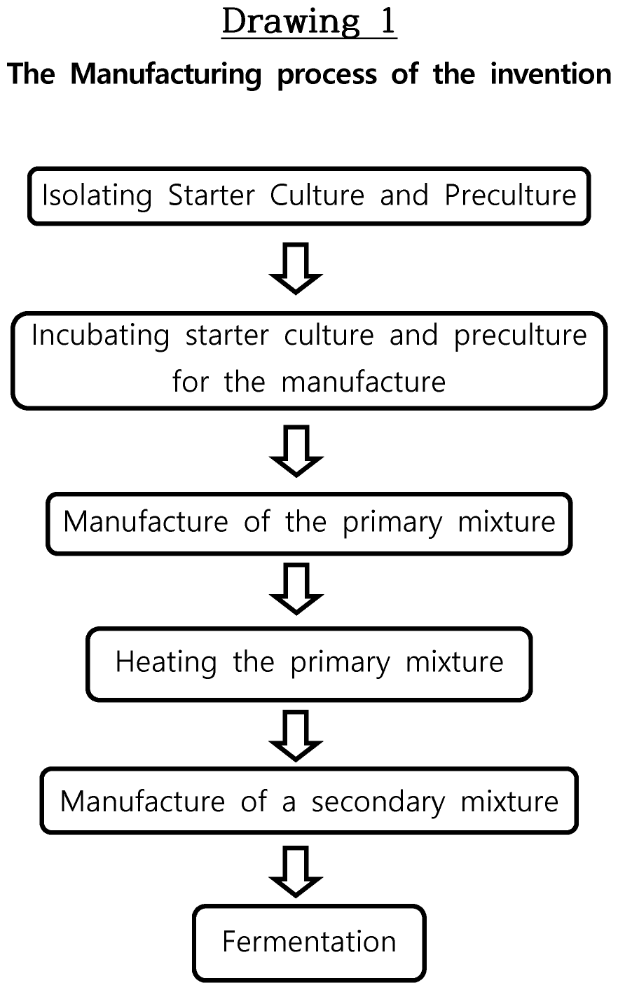

### CROSS-REFERENCE TO RELATED APPLICATION

This application is related to and claims the benefit of priority of International Application No. PCT/KR2019/000172, entitled, “Fertilizer Using Fish and Wild Animal and Manufacturing Method Thereof”, filed on Jul. 1, 2019, which is hereby incorporated by reference.

### BACKGROUND INFORMATION

### 1. Field

The present disclosure relates to a water-soluble amino acid-based fertilizer using fish and wild animal and how it is manufactured in the form of liquid or powder, and more specifically, to a mixture of crushed fish and organic substances from corn stalks (or sawdust) and rice bran to boil together, and when fermenting the above boiled mixture, crushed Peat Moss, Elvan, Tourmaline, Zeolite, Sericite, and Minerals from Red Clay are to be added.

### 2. Background

Present day's agriculture is facing a critical turning point. The worldwide Free Trade Agreement (FTA) has opened the way for cheap agricultural products to be distributed. Of course, it does not mean that all the smaller farms will wither away because of the FTA, but in reality, most of the farmers cannot compete in price with imported agricultural products under the normal farming methods. Thus, organic agricultural products that are safe, clean, and well-being-driven can be considered as a way to solve these real problems.

However, it is not easy to actively consider organic farming in the reality of our rural areas, which have developed with the help of pesticides, herbicides, and chemical fertilizers over the past few decades. Many farms are facing real challenges while trying to farm organically.

This is because direct and indirect problems are occurring, such as access by pesticides or pests from neighboring fields, and lack of soil fertility causing a large decrease in yields by as much as 70%. However, organic farming is steadily growing as farming methods are also being studied in a variety of ways, and experience is accumulating. But it has not been actively utilized due to lack of truthful eco-friendly farming materials or a lack of awareness of eco-friendly farming materials.

Meanwhile, Largemouth Bass (Micropterus salmoides), is a fish species introduced into many countries for sport fishing or a food resource. This fish in its strong activity and top predator position, and in some severe cases, more than 70 percent of fish are Largemouth Bass. Bass' appetite is strong enough to surpass that of native carnivorous fish, so many kinds of small native fish are becoming food for Bass. Decreasing the number of small fish causes a gradual decline in water quality, and mosquitoes and other larvae activity is dramatically increased. To alleviate those problems, finding a way of practical use of unwanted fish is necessary.

Developing organic fertilizers using the above-mentioned bass as raw materials, we can restore the ecosystem and produce eco-friendly organic fertilizers that are highly nutritious and including amino acids, but there has never been a case where such an idea has been formulated. On Sep. 19, 2008, Republic of Korea Patent Registration No. 10-0860351 (Methods for making fertilizer from Bass and fertilizer manufactured from Bass) has registered. The Patent includes the stage of the mixture of Bass and fermented microorganisms and initiating fermentation Performance to form a mixture. However, by the method of making fertilizer from Bass such as the above, and by the process of fermenting them by mixing and fermenting them with fermented microorganisms, plants were encouraged to grow, but they were not adequately provided with an environment to help the growth of plants better without basal fertilization.

Farm-damaging wild animals such as wild boar and water deer also present disposal trouble after they are exterminated by hunting or road-killed. To solve that problem, on Oct. 21, 2008, Republic of Korea Patent Registration No. 10-0865632 (Equipment for making Liquid fertilizer from the carcass of livestock) has registered. The liquid fertilizer from the carcass is produced by acid (HCl) decomposition method. After hydrolyzation, neutralization with caustic soda (NaOH) treatment will filter out the solid residue from the solution which will produce fluid fertilizer. The equipment's components are main effector, control box, neutralizing equipment, specimen feeder, pump. The liquefying tank is a triple jacket made of stainless steel (SUS304) including cover, eyebolt, safety lock.

The heater is placed on the 2^{nd} layer, the insulation is on 3^{rd}, thermometer and pressure gauge inside. However, the process of making liquid fertilizer with the carcass of livestock through the method of acid decomposition, neutralization with caustic soda, filtering out the solid residue from the solution, and mixing with phosphoric acid and potassium to fortify the fertilizer is too complicated and had trouble balancing nutrients

### SUMMARY

An illustrative embodiment provides a method of manufacturing fertilizer. The method comprises preparing a primary mixture comprising of 80 to 90 percent in weight of crushed fish less than 100 mesh in size, 5 to 10 percent in weight of corn stalk less than 100 mesh in size, and 5 to 10 percent in weight of rice bran less than 100 mesh in size. The primary mixture is boiled at twice barometric pressure to obtain an extracted mixture. A secondary mixture is prepared comprising 86 to 93 percent in weight of the extracted mixture and 1 to 2 percent in weight of powdered, smaller than 100 mesh size, peat moss, elvan, tourmaline, zeolite, sericite, and minerals from red clay. The secondary mixture is fermented with lactobacillus.

Another illustrative embodiment provides a method of manufacturing fertilizer. The method comprises preparing a primary mixture comprising of 80 to 90 percent in weight of crushed wild animal less than 100 mesh in size, 5 to 10 percent in weight of sawdust less than 100 mesh in size, and 5 to 10 percent in weight of rice bran less than 100 mesh in size. The primary mixture is boiled at twice barometric pressure to obtain an extracted mixture. A secondary mixture is prepared comprising 94 to 97 percent in weight of the extracted mixture and 0.5 to 1 percent in weight of powdered, smaller than 100 mesh size, peat moss, elvan, tourmaline, zeolite, sericite, and minerals from red clay. The secondary mixture is fermented with lactobacillus.

The features and functions can be achieved independently in various embodiments of the present disclosure or may be combined in yet other embodiments in which further details can be seen with reference to the following description and drawings.

### BRIEF DESCRIPTION OF THE DRAWING

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawing, wherein:

Drawing 1 depicts a flowchart illustrating a process of manufacturing fertilizer in accordance with an illustrative embodiment.

### DETAILED DESCRIPTION

The illustrative embodiments boil corn stalk and rice bran together with crushed fish and wild animal as raw material, and provide a method of making fertilizer using fish and wild animal to produce a liquid or powder with water-soluble amino acids by mixing the mineral substances of crushed Peat Moss, Elvan, Tourmaline, zeolite, Sericite, and Minerals from Red Clay added when fermenting the above boiled mixture.

Specifically, the illustrative embodiments mix the crushed fish, corn stalk, and rice bran organic matter, which is smaller than 100 mesh in size, and boil for 3˜6 hours at a temperature above 100° C. to extract a mixture obtaining plentiful organic matter. When fermenting the extracted mixture above, a mixture of Peat Moss, Elvan, tourmaline, zeolite, Sericite, and Minerals from Red Clay that have been crushed to a size of less than 100 mesh is added to the mixture, and then fermented microorganisms are added to ferment to generate far-infrared and anions to help the growth of plants.

The main stages of the process comprise:

The first stage is making the mixture “A” by mixing the crushed fish and wild animal with the organic matter of corn stalk and ricebran organic matter which is less than 100 mesh in size.

The second stage is boiling the mixture “A” from the first stage for 3˜6 hours at 2 barometric pressure at a temperature above 100° C. to extract the mixture.

The third stage is making the mixture “B” by adding Peat Moss, Elvan, tourmaline, zeolite, Sericite, and Minerals from Red Clay to the Mixture “A”.

The fourth stage is fermenting mixture “B” after adding lactobacillus and minerals from red clay to a water-soluble easy-to-use liquid or powder form of fertilizer.

The extracted mixture boiled by mixing corn stalk and rice bran with fish is almost 100% water-soluble, easy to ferment, contains high-quality amino acids and organic substances, and has the advantage of being produced in a short period because of less odor and gas-forming in the final product. Also, trace elements such as calcium, phosphorus, and zinc from the extraction process are water-soluble parts that are easy for crops to absorb.

Fermented microorganisms used to ferment the secondary Mixture (mixture “B”) are Lactobacillus acidophilus or Lactobacillus fermentum. The above microorganisms are one of the strains which break down protein into amino acids faster than others and are able to proceed with the process without being affected by the acidification of the fermenting solution during the fermentation process. Lactobacillus acidophilus or Lactobacillus fermentum also have the advantage when large amounts of organic acids are produced during lactic acid fermentation which will improve the quality of liquid fertilizers by preventing the multiplication of saprogen and pathogens, and when they are manufactured, they help the health of the crops. The addition of minerals during the fermentation of the plant will help in the production of microorganisms.

Adding minerals to the fermentation process helps microorganisms grow. It is recommended that the above fermentation be carried out with aeration. Through aeration, the culture medium can be evenly mixed and the efficiency of fermentation can be improved. It is recommended that the above fermentation be carried out immediately after the commencement of fermentation for 1 or 2 days at 30° C. to 40° C. and then further fermentation at room temperature.

It is recommended that the above fermentation be carried out for 7˜10 days with little fermentation bubbles occurring in the fermenting solution. This is because it means the fermentation has progressed to saturation.

To obtain fertilizer in powder form, include additional steps to dry the filtered fermented fluid through various methods. For example, spray drying can be obtained in powder form. Fertilizers in powder form can be more efficient in transportation and processing than in liquid form.

The above method can be used on fish and wild animals at the same time or separately.

The above-mentioned process, combining fish and/or wild animals with the corn stalk and rice bran effectively renders resources to help and protect the environment. Fertilizers manufactured can be used as a substitute for chemical fertilizers to prevent soil acidification and can greatly help farmers grow their eco-friendly crops. Also, since the whole production process is carried out only with water-soluble materials, there is an advantage of being absorbed and used immediately when applied to crops and plants. In addition, through this invention, the organic acids produced by the fermented microorganisms and the anions and far-infrared rays produced give plants and crops the power to fight off disease and pests. Fish fertilizers can also be expected to have a secondary effect.

Drawing 1 depicts a flowchart illustrating a process of manufacturing fertilizer using unwanted fish, including harmful species such as largemouth bass (classified as an invasive species in many countries) in accordance with an illustrative embodiment.

Step 1: Isolating starter culture and preculture

The organic lactobacillus can be isolated from kimchi as a starter culture and preculture for the manufacture of this invention, water-soluble amino acid fertilizer.

In Example 1, we chose Lactobacillus acidophilus.

In Example 2, we chose Lactobacillus fermentum.

The stock was first activated on a De Man, Rogosa and Sharpe (MRS) (modified MRS broth) medium, and then the pilot cultivation in 100 liters was performed for pre-cultivation. In the pilot cultivation, the pH level was kept at 4 to 4.5 at 45° C. Pilot cultivation gives tolerance to pH shock and heat shock that occur during storage after manufacture and completion of the product. The fermented microorganisms of this invention were then prepared by packing after the powder was obtained.

Step 2: Incubating starter culture and preculture for the manufacture

For the manufacture of this invention, water-soluble amino acid fertilizer, starter culture, and preculture for the manufacture are using Bacillus are the natural strains isolated from the incubator, the bacillus subtilis, which were separated from the PCS culture medium, and preserved in agar stock.

The stock was first activated on a liter basis in the Nutrient Broth medium, and then the pilot incubation in 100 liters was performed. During pilot incubation, pH was maintained at 4.5 to 5 at 40° C. Pilot culture gives resistance to pH shock and heat shock that occur when storing after manufacture and completion of the product.

The fermented microorganisms of this invention were then prepared by packing after the powder was obtained.

Step 3: Manufacture of the primary mixture

Prepare the primary mixture by mixing 80 to 90% in weight of crushed fish smaller than 100 mesh, 5 to 10% in weight of cornstalk smaller than 100 mesh, and 5 to 10% in weight of rice bran smaller than 100 mesh.

In another embodiment, the primary mixture might comprise 80 to 90% in weight of crushed wild animal smaller than 100 mesh, 5 to 10% in weight of sawdust smaller than 100 mesh, and 5 to 10% in weight of rice bran smaller than 100 mesh. The wild animal might comprise fish, wild boar and/or water deer.

Step 4: Heating the primary mixture

Bring the above primary mixture to a boil for 3 to 6 hours at 2 barometric pressure at a temperature above 100° C.

Step 5: Manufacture of a secondary mixture

Prepare a secondary mixture by mixing the above extracted mixture with the minerals of crushed Peat Moss, Elvan, Tourmaline, zeolite, Sericite, and Minerals from Red Clay which have been crushed to a size of not more than 100 mesh. The mixing rate is 86˜93% in weight of the extracted mixture to 1˜2% in weight of crushed minerals.

In another illustrative embodiment, the secondary mixture comprises 94 to 97% in weight of the extracted mixture and 0.5 to 1% in weight of the crushed minerals.

Step 6: Fermentation

Add the fermented lactobacillus and minerals extracted from Step 1 and Step 2 above to the above secondary mixture for fermentation.

An analysis of the ingredients of the fertilizer manufactured in the above example showed 0.92 g/kg of nitrogen, 0.57 g/kg of phosphoric acid, 1.05 g/kg of potassium, 0.23 g/kg of calcium, 14.3 g/kg of total organic matter, 3.29 mg/kg of total amino acid, 0.08 g/kg of sodium, 0.0 mg of arsenic, 0.0 mg/kg of mercury, 0.0 mg/kg of lead, 0.1 mg/kg of chrome, 0.7 mg/kg of copper, 0.3 mg/kg of nickel, 3.9 mg/kg of zinc.

Using fish that are unwanted or harmful to the local ecosystem to produce quality amino acids rich fertilizer produced in large quantities is a good secondary resource while reducing environmental pollution and naturally fertilizing the farm fields at the same time.

Although this invention has been described and illustrated in the above, it is not limited to the above-mentioned practice, and any person with a general knowledge in the field to which this invention belongs will be able to carry out various variations and such changes will be within the scope of the claim.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

The description of the different illustrative embodiments has been presented for purposes of illustration and description and is not intended to be exhaustive or limited to the embodiments in the form disclosed. Many modifications and variations will be apparent to those of ordinary skill in the art. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of manufacturing fertilizer, the method comprising:
preparing a primary mixture comprising:
80 to 90 percent in weight of crushed fish less than 100 mesh in size;
5 to 10 percent in weight of corn stalk less than 100 mesh in size;
5 to 10 percent in weight of rice bran less than 100 mesh in size;
boiling the primary mixture at 2 barometric pressure to obtain an extracted mixture; and
preparing a secondary mixture comprising:
86 to 93 percent in weight of the extracted mixture;
1 to 2 percent in weight of powdered, smaller than 100 mesh size, peat moss, elvan, tourmaline, zeolite, sericite, and minerals from red clay; and
fermenting the secondary mixture with lactobacillus.

2. The method of claim 1, wherein the primary mixture is boiled for 3-6 hours.

3. The method of claim 1, wherein the primary mixture is boiled at a temperature above 100° C.

4. The method of claim 1, wherein lactobacillus comprises lactobacillus acidophilus or lactobacillus fermentum.

5. The method of claim 1, wherein the lactobacillus used to ferment the secondary mixture is obtained by:
isolating a starter culture and preculture of lactobacillus;
cultivating the starter culture and preculture at 45° C. at a pH level of 4 to 4.5;
incubating the starter culture and preculture at 40° C. at a pH level of 4 to 4.5; and
packing the lactobacillus as a powder.

6. The method of claim 1, further comprising fixating, filtering, and drying the secondary mixture after fermentation.

7. The method of claim 1, wherein fermentation is carried out with aeration.

8. The method of claim 1, wherein fermentation occurs for one to two days at a temperature of 30° C. to 40° C. followed by fermentation at room temperature for a total of 7 to 10 days.

9. A method of manufacturing fertilizer, the method comprising:
preparing a primary mixture comprising:
80 to 90 percent in weight of crushed wild animal less than 100 mesh in size;
5 to 10 percent in weight of saw dust less than 100 mesh in size;
5 to 10 percent in weight of rice bran less than 100 mesh in size;
boiling the primary mixture at 2 barometric pressure to obtain an extracted mixture; and
preparing a secondary mixture comprising:
94 to 97 percent in weight of the extracted mixture;
0.5 to 1 percent in weight of powdered, smaller than 100 mesh size, peat moss, elvan, tourmaline, zeolite, sericite, and minerals from red clay; and
fermenting the secondary mixture with lactobacillus.

10. The method of claim 9, wherein the primary mixture is boiled for 3-6 hours.

11. The method of claim 9, wherein the primary mixture is boiled at a temperature above 100° C.

12. The method of claim 9, wherein lactobacillus comprises lactobacillus acidophilus or lactobacillus fermentum.

13. The method of claim 9, wherein the lactobacillus used to ferment the secondary mixture is obtained by:
isolating a starter culture and preculture of lactobacillus;
cultivating the starter culture and preculture at 45° C. at a pH level of 4 to 4.5;
incubating the starter culture and preculture at 40° C. at a pH level of 4 to 4.5; and
packing the lactobacillus as a powder.

14. The method of claim 9, further comprising fixating, filtering, and drying the secondary mixture after fermentation.

15. The method of claim 9, wherein fermentation is carried out with aeration.

16. The method of claim 9, wherein fermentation occurs for one to two days at a temperature of 30° C. to 40° C. followed by fermentation at room temperature for a total of 7 to 10 days.

17. The method of claim 9, wherein the wild animal comprises at least one of:
fish;
wild boar; or
water deer.
